(19) United States
(12) Patent Application Publication
(10) Pub. No.: US 2010/0157917 A1
(43) Pub. Date: Jun. 24, 2010

(54) RESOURCE ALLOCATION MAPPING APPARATUS AND METHOD FOR TRANSMITTING CSRS, AND CSRS TRANSMITTING APPARATUS AND METHOD

(75) Inventors: Chan Bok JEONG, Daejeon (KR); Dae Ho KIM, Daejeon (KR); Yeong Jin KIM, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/541,392

(22) Filed: Aug. 14, 2009

(30) Foreign Application Priority Data
Dec. 19, 2008 (KR) 10-2008-0130211

(51) Int. Cl. H04W 72/04

(52) U.S. Cl. 370/329

(57) ABSTRACT

Provided are a resource allocation mapping apparatus and method for transmitting CSRS, the resource allocation mapping method includes calculating subcarrier indexes to allocate same subcarrier index to base stations that have same remainder when a base-station index, which classifies the base stations, is divided by a constant; and mapping a resource allocation of the CSRS for the each base station using the calculated subcarrier indexes.

### CROSS-REFERENCE TO RELATED APPLICATIONS

This application claims priority under 35 U.S.C. §119 to Korean Patent Application No. 10-2008-0130211, filed on Dec. 19, 2008, the disclosure of which is incorporated herein by reference in its entirety.

### TECHNICAL FIELD

The present disclosure relates to a resource allocation for transmitting a Cell-Specific Reference Signal (CSRS) in a base-station modulator applied to an LTE-Advanced system that is one of IMT-Advanced candidate technologies.

### BACKGROUND

In the related art, the resource allocation of a CSRS is performed according to a transmission bandwidth, the number of transmission antennas, a hopping pattern (Hopping-ID), the position of an Orthogonal Frequency Division Multiplexing (OFDM) symbol intended to transmit and a cyclic prefix type. Therefore the process for the resource allocation of a CSRS is complicated.

### SUMMARY

Accordingly, the present disclosure relates to a base-station modulator applied to an LTE-Advanced system that is one of IMT-Advanced technologies, and provides a method that very simply calculates a subcarrier index for resource allocation mapping of a CSRS and punctures a subcarrier which is not used in the resource allocation mapping and transmitting of the CSRS using the calculated subcarrier index, thereby enabling to very easily implement the base-station modulator.

The objects of the present invention are not limited to the above-described object, and the objects and advantages of the present invention other than the above-described object can be understood by description below and will be more apparent with reference to the embodiments of the present invention.

According to an aspect, there is provided a resource allocation mapping method for transmitting a CSRS, and the resource allocation mapping method includes: calculating subcarrier indexes to allocate same subcarrier index to base stations that have same remainder when a base-station index, which classifies the base stations, is divided by a constant; and mapping a resource allocation of the CSRS for the each base station using the calculated subcarrier indexes.

According to another aspect, there is provided a resource allocation mapping method for transmitting a CSRS, and the resource allocation mapping method includes: calculating each subcarrier index using Equations (1) and (2) below; and mapping a resource allocation of the CSRS using the calculated subcarrier index,

$$\begin{matrix} k = m \times 6 + {N}_{ID}^{cell} mod 6 , m = 0 , 1 , … , 2 \cdot {N}_{RB}^{DL} - 1 & ( 1 ) \\ k = \{ \begin{matrix}m \times 6 + {N}_{ID}^{cell} mod 3 , m = 0 , 1 , … , 2 \cdot {N}_{RB}^{DL} - 1 & if {N}_{ID}^{cell} mod 6 > 2 \\ m \times 6 + {N}_{ID}^{cell} mod 3 + 3 , m = 0 , 1 , … , 2 \cdot {N}_{RB}^{DL} - 1 & if {N}_{ID}^{cell} mod 6 \leq 2\end{matrix} & ( 2 )\end{matrix}$$

where N_{ID}^{cell} is an index given to the each base station, and N_{RB}^{DL} is the total number of resource blocks used in the down-link from the each base station.

According to another embodiment, there is provided a CSRS transmitting apparatus, and the CSRS transmitting apparatus includes: a calculation unit calculating subcarrier indexes to allocate the same subcarrier index to base stations that have same remainder when a base-station index, which classifies the base stations, is divided by a constant; and a transmission unit mapping a resource allocation of the CSRS for the each base station using the calculated subcarrier indexes to transmit the mapped CSRS.

According to another embodiment, there is provided a CSRS transmitting apparatus, and the CSRS transmitting apparatus includes: first and second calculation units calculating subcarrier indexes using Equations (1) and (2) below; and a transmission unit mapping a resource allocation of the CSRS using the calculated subcarrier indexes to transmit the mapped CSRS,

$$\begin{matrix} k = m \times 6 + {N}_{ID}^{cell} mod 6 , m = 0 , 1 , … , 2 \cdot {N}_{RB}^{DL} - 1 & ( 1 ) \\ k = \{ \begin{matrix}m \times 6 + {N}_{ID}^{cell} mod 3 , m = 0 , 1 , … , 2 \cdot {N}_{RB}^{DL} - 1 & if {N}_{ID}^{cell} mod 6 > 2 \\ m \times 6 + {N}_{ID}^{cell} mod 3 + 3 , m = 0 , 1 , … , 2 \cdot {N}_{RB}^{DL} - 1 & if {N}_{ID}^{cell} mod 6 \leq 2\end{matrix} & ( 2 )\end{matrix}$$

where N_{ID}^{cell} is an index given to the each base station, and N_{RB}^{DL} is the total number of resource blocks used in the down-link from the each base station.

The specific matters of other embodiments are included in detailed description and the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a block diagram of a CSRS transmitting apparatus according to an embodiment of the present invention;

FIG. 2 is a conceptual diagram for describing a first calculation unit of FIG. 1;

FIG. 3 is a conceptual diagram for describing a second calculation unit of FIG. 1; and

FIGS. 4A to 4C are flowcharts illustrating a resource allocation mapping method for transmitting a CSRS and a CSRS transmitting method according to an embodiment of the present invention.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, embodiments will be described in detail with reference to the accompanying drawings.

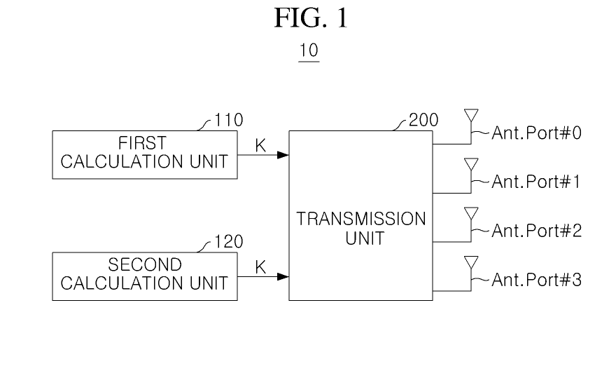

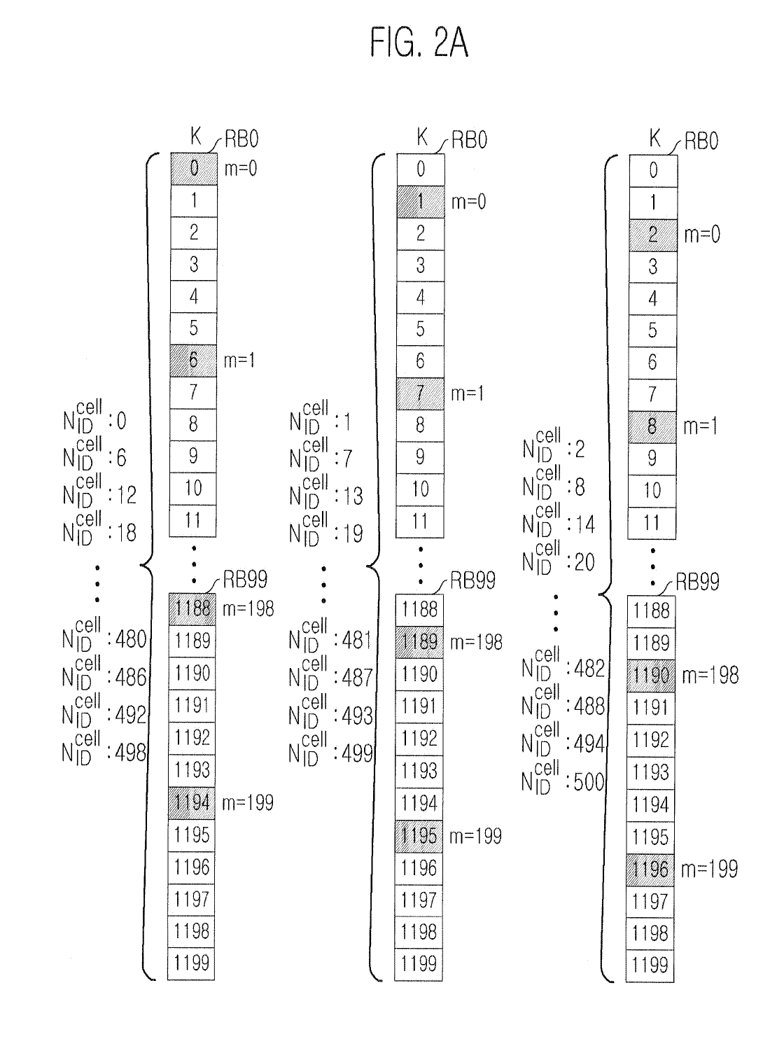

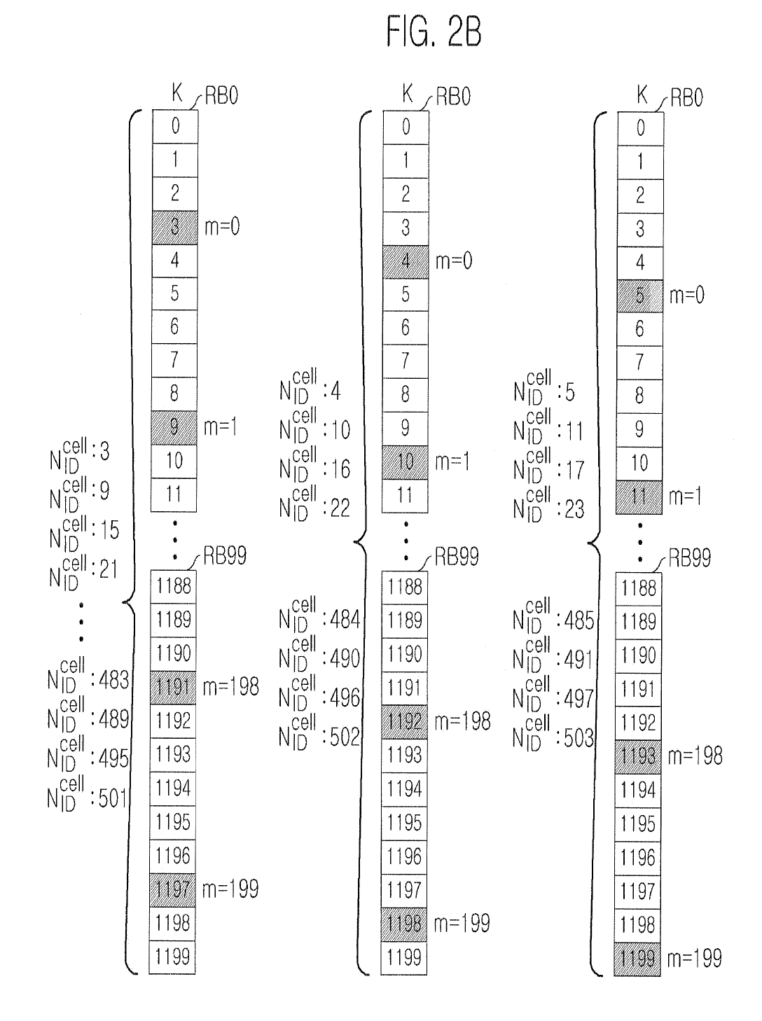

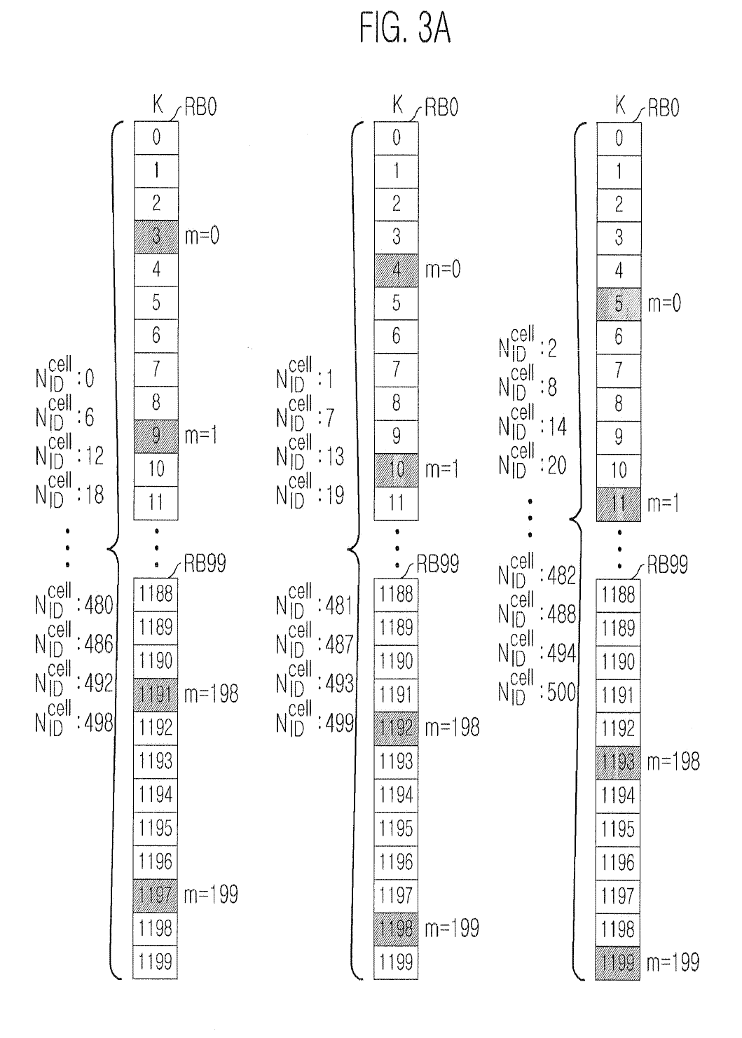

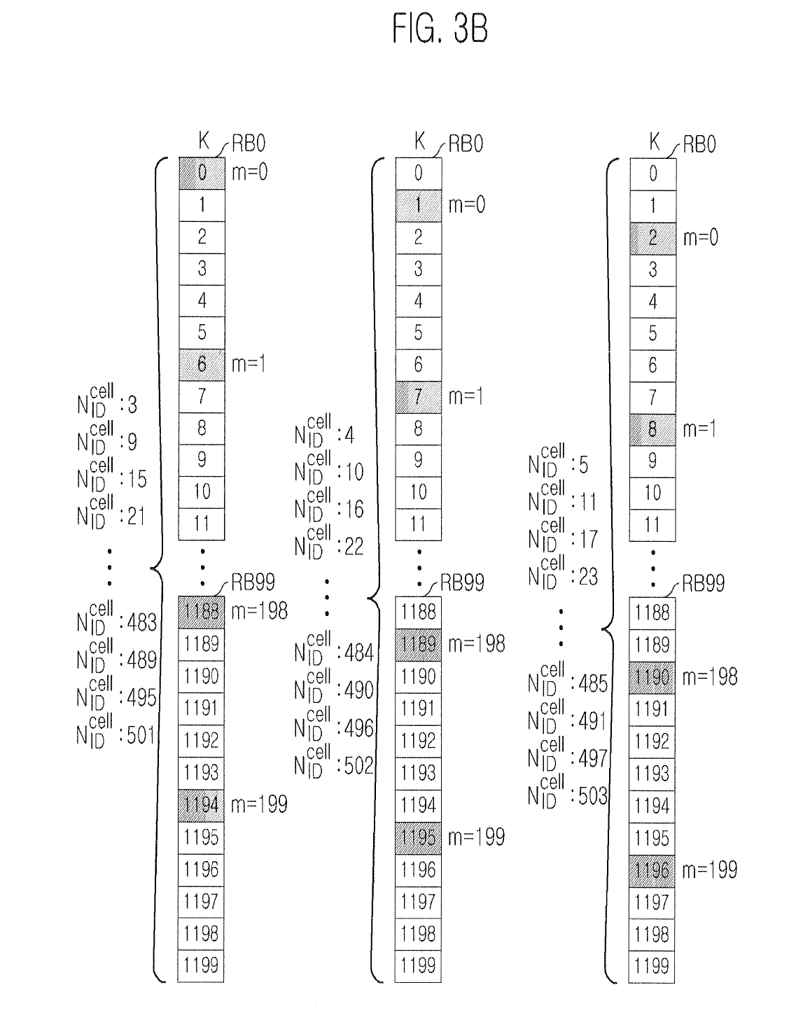

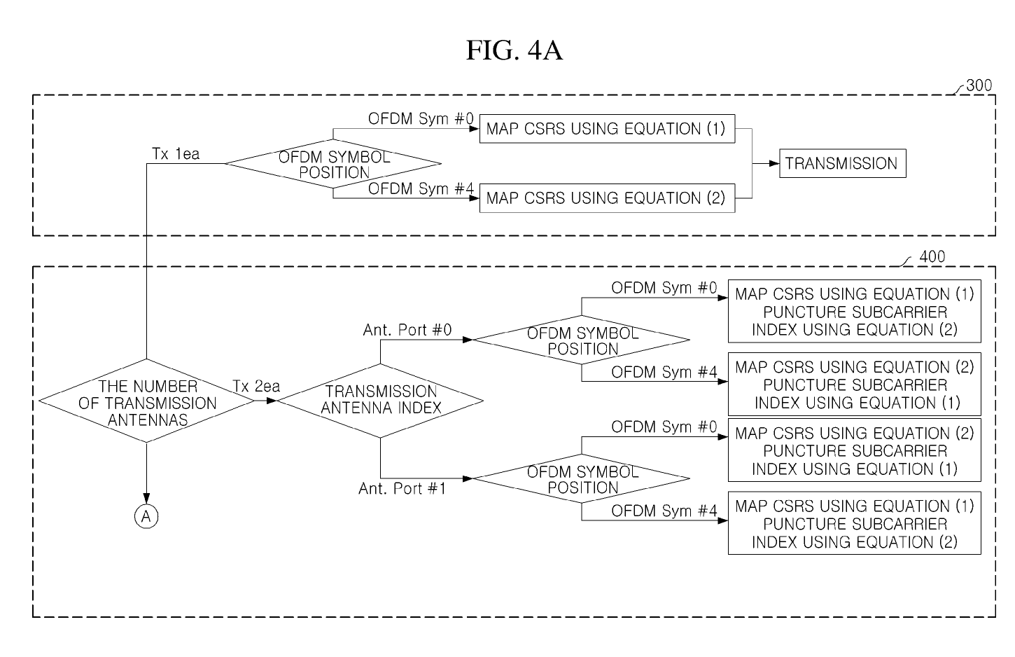

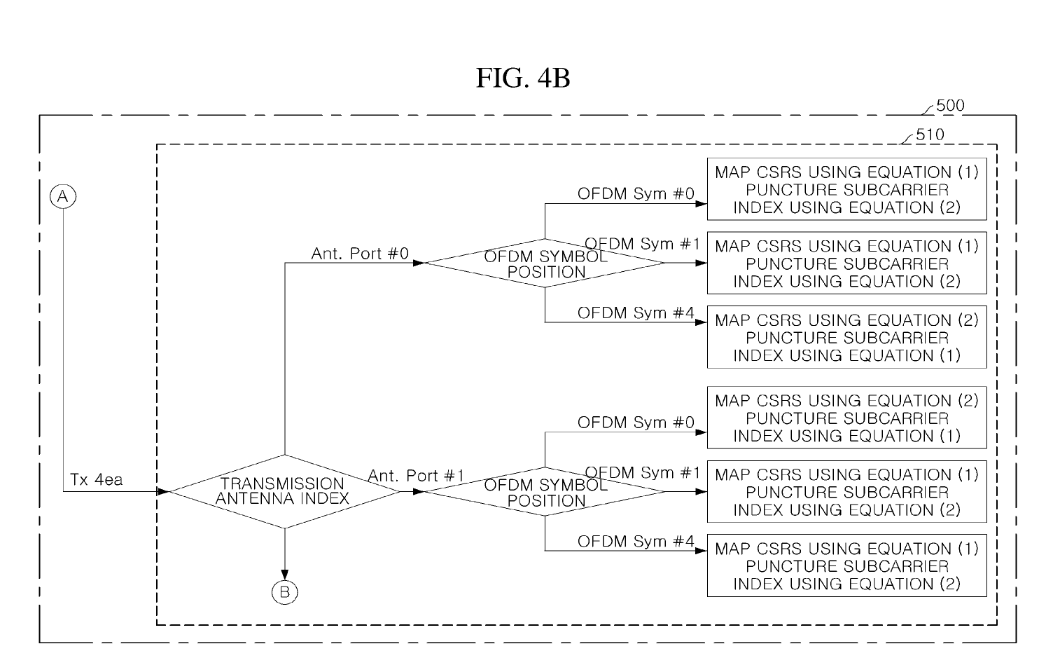

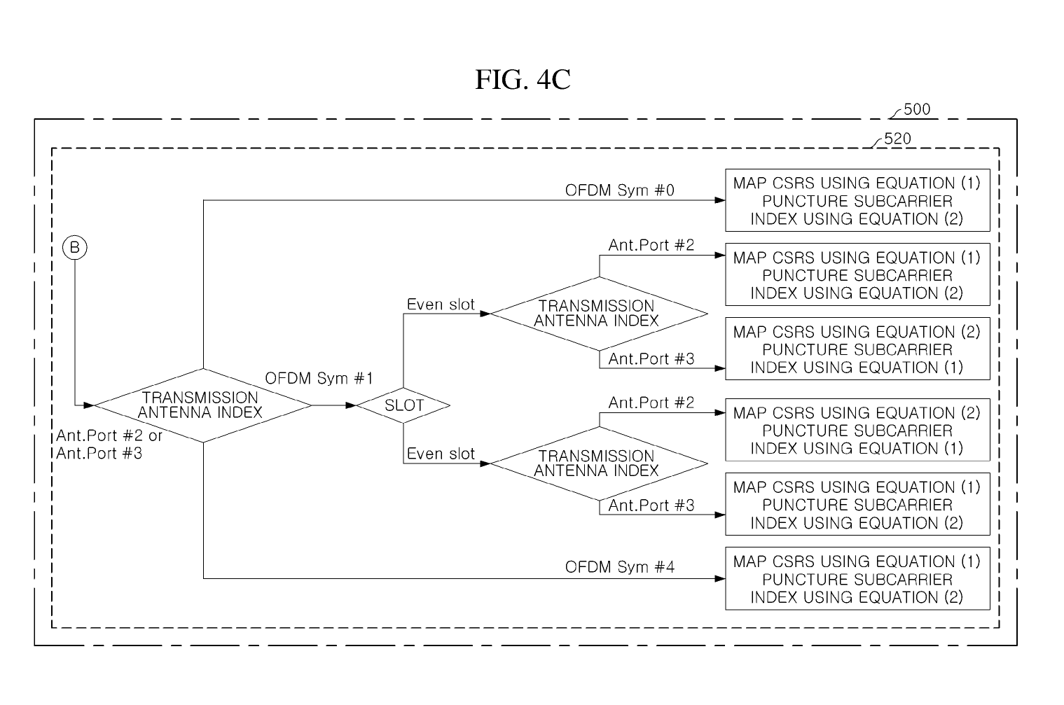

The following description will be made with reference to FIGS. 1 to 4 on a resource allocation mapping method and apparatus for transmitting CSRS, and a CSRS transmitting method and apparatus according to an embodiment of the present invention. FIG. 1 is a block diagram of a CSRS transmitting apparatus according to an embodiment of the present invention. FIG. 2 is a conceptual diagram for describing a first calculation unit of FIG. 1. FIG. 3 is a conceptual diagram for describing a second calculation unit of FIG. 1. FIGS. 4A to 4C are flowcharts illustrating a resource allocation mapping method for transmitting a CSRS and a CSRS transmitting method according to an embodiment of the present invention.

Hereinafter, as an example, the following description will be made on a case where transmission Time Interval (TTI) may be composed of one even slot and one odd slot, and the each slot is composed of seven OFDM symbols #0 to #6. However, the present invention may be embodied in different forms and should not be construed as limited to the embodiments set forth herein.

Referring to FIG. 1, the CSRS transmitting apparatus 10 includes a first calculation unit 110, a second calculation unit 120, and a transmission unit 200. The first and second calculation units 110 and 120 calculate a subcarrier indexes k to allocate same subcarrier index k to base stations that have same remainder when a base-station index (which classifies the base stations) is divided by a constant. For example, the first and second calculation units 110 and 120 may calculate the subcarrier index k to allocate same subcarrier index k to base stations that have same remainder when the base-station index is divided by 6.

As specific example, the first calculation unit 110 calculates the subcarrier indexes k for the resource allocation mapping of the CSRS by using Equation (1) below, and the second calculation unit 120 calculates the subcarrier indexes k for the resource allocation mapping of the CSRS by using Equation (2) below.

$$\begin{matrix} k = m \times 6 + {N}_{ID}^{cell} mod 6 , m = 0 , 1 , … , 2 \cdot {N}_{RB}^{DL} - 1 & ( 1 ) \\ k = \{ \begin{matrix}m \times 6 + {N}_{ID}^{cell} mod 3 , m = 0 , 1 , … , 2 \cdot {N}_{RB}^{DL} - 1 & if {N}_{ID}^{cell} mod 6 > 2 \\ m \times 6 + {N}_{ID}^{cell} mod 3 + 3 , m = 0 , 1 , … , 2 \cdot {N}_{RB}^{DL} - 1 & if {N}_{ID}^{cell} mod 6 \leq 2\end{matrix} & ( 2 )\end{matrix}$$

where N_{ID}^{cell} (hereinafter, referred to as a base-station index) is a physical layer identifier and is given to each base station, and N_{RB}^{DL} is the total number of resource blocks used in the down-link of a base-station system.

In a transmission bandwidth 20 MHz, the N_{RB}^{DL} is set into 100 (for example, RB0 to RB99), and the N_{ID}^{cell} is one of values of 0 to 503. As an example, the following description will be made with reference to FIGS. 2 to 3 in detail on the first and second calculation units 110 and 120 in a case where one value is used in one base station.

In FIG. 2, the subcarrier indexes k that the first calculation unit 110 has calculated by the Equation (1) is illustrated in shadow. Specifically, the first calculation unit 110 calculates the subcarrier indexes k for the subcarrier index (k) of 0, 6 to 1188 and 1194 to be allocated to a base station (the base-station index value: 0, 6, and 12 to 498) where the remainder of the base-station index divided by 6 is 0. That is, when the base-station index of a base station including the first calculation unit 110 is one of 0, 6 and 12 to 498, the first calculation unit 110 calculates the subcarrier indexes k of 0, 6 to 1188 and 1194. When the base-station index of the base station including the first calculation unit 110 is one of 1, 7 and 13 to 499 (a case where the remainder of the base-station index divided by 6 is 1), the first calculation unit 110 calculates the subcarrier indexes k of 1, 7 to 1189 and 1195. Alternatively, when the base-station index of the base station including the first calculation unit 110 is one of 2, 8 and 14 to 500 (a case where the remainder of the base-station index divided by 6 is 2), the first calculation unit 110 calculates the subcarrier indexes k of 2, 8 to 1190 and 1196.

In this way, the first calculation unit 110 calculates the subcarrier indexes k for the same subcarrier index k to be allocated to base station where the remainder of the base-station index divided by 6 is identical. That is, the first calculation unit 110 calculates the subcarrier indexes k by the Equation (1).

The second calculation unit 120 also calculates the subcarrier indexes k for the same subcarrier index (k) to be allocated to base station where the remainder of the base-station index value divided by 6 is identical. At this point, the second calculation unit 120 uses the Equation (2) unlike the first calculation unit 110. That is, the second calculation unit 120 calculates the subcarrier indexes k as illustrated in shadow in FIG. 4.

The following description will be made with reference to FIGS. 4A to 4C on the operation of the CSRS transmitting apparatus of FIG. 1.

First, the following description will exemplify a case 300 where the transmission unit 200 transmits the CSRS with one transmission antenna.

In a case where the transmission unit 200 transmits the CSRS with one transmission antenna, the transmission unit 200 may map the resource allocation of the CSRS in consideration of the position of a transmitted OFDM symbol.

Specifically, the transmission unit 200 sequentially maps the CSRS using the subcarrier indexes k calculated by the Equation (1) at a time of the OFDM symbol #0, sequentially maps the CSRS using the subcarrier indexes k calculated by the Equation (2) at a time of the OFDM symbol #4, and transmits the mapped CSRS. Such a method is identically applied to the even slot and the odd slot where the CSRS are transmitted. In a case of using one transmission antenna, puncturing is not performed because there is no subcarrier that is not used to transmit CSRS.

The following description will exemplify a case 400 where the transmission unit 200 transmits the CSRS with two transmission antennas.

In a case where the transmission unit 200 transmits the CSRS with two transmission antennas, the transmission unit 200 may map the resource allocation in consideration of a transmission antenna index and the position of an OFDM symbol.

At a time of the OFDM symbol #0 transmitted through a first transmission antenna having a transmission antenna index of Ant.Port#0, the transmission unit 200 sequentially maps the CSRS using the subcarrier indexes k calculated by the Equation (1) to transmit the mapped CSRS, and punctures the subcarrier indexes k calculated by the Equation (2) to prevent signals from being transmitted.

At a time of the OFDM symbol #4 transmitted through a second transmission antenna having a transmission antenna index of Ant.Port#1, the transmission unit 200 sequentially maps the CSRS using the subcarrier indexes k calculated by the Equation (2) to transmit the mapped CSRS, and punctures the subcarrier indexes k calculated by the Equation (1) to prevent all signals from being transmitted.

At a time of the OFDM symbol #0 transmitted through the second transmission antenna, the transmission unit 200 sequentially maps the CSRS using the subcarrier indexes k calculated by the Equation (2) to transmit the mapped CSRS, and punctures the subcarrier indexes k calculated by the Equation (1) to prevent signals from being transmitted.

At a time of the OFDM symbol #4 transmitted through the second transmission antenna, the transmission unit 200 sequentially maps the CSRS using the subcarrier indexes k calculated by the Equation (1) to transmit the mapped CSRS, and punctures the subcarrier indexes k calculated by the Equation (2) to prevent signals from being transmitted. At this point, such a method is identically applied to the even slot and the odd slot where the CSRS are transmitted.

The following description will exemplify a case 500 where the transmission unit 200 transmits the CSRS with four transmission antennas.

In a case where the transmission unit 200 transmits the CSRS with four transmission antennas, the transmission unit 200 may map the resource allocation of the CSRS in consideration of the transmission antenna index and the position of the OFDM symbol. Specifically, the transmission unit 200 performs resource allocation mapping and puncturing at the even slot and the odd slot in the same method 510, or performs resource allocation mapping and puncturing at the even slot and the odd slot in different methods 520, according to the transmission antenna index. That is, the transmission unit 200 performs resource allocation mapping and puncturing in the same method at an even slot and an odd slot which are transmitted through the first and second antennas Ant.Port#0 and Ant.Port#1 in the sub-case 510. The transmission unit 200 performs resource allocation mapping and puncturing in the same method at the even slot and the odd slot which are transmitted through a third antenna having a transmission antenna index of Ant.Port#2 and a fourth antenna having a transmission antenna index of Ant.Port#3 in the sub-case 520.

Specifically, when the transmission unit 200 performs resource allocation mapping and puncturing in the same method at the even slot and the odd slot which are transmitted through the first and second antennas Ant.Port#0 and Ant.Port#1 in the sub-case 510, resource allocation mapping and puncturing is performed like the case 400 upon transmission to the first and second transmission antennas. Furthermore, in a case of the OFDM symbol #1, the transmission unit 200 punctures the subcarrier indexes k which are respectively calculated from the Equations (1) and (2) by the first and second calculation units 110 and 120 to prevent signals from being transmitted.

When the transmission unit 200 performs resource allocation mapping and puncturing in different methods at the even slot and the odd slot which are transmitted through the third and fourth transmission antennas Ant.Port#2 and Ant.Port#3 in the sub-case 520, the transmission unit 200 respectively punctures the subcarrier indexes k which are calculated from the Equations (1) and (2) by the first and second calculation units 110 and 120 at a time of the OFDM symbol #0 and OFDM symbol #4 of the even and odd slots which are transmitted through the third and fourth transmission antennas, to prevent signals from being transmitted. Furthermore, the transmission unit 200 performs the resource allocation of the CSRS for the OFDM symbol #1 in different methods according to a slot index and an antenna index.

At a time of the OFDM symbol #1 of the even slot transmitted through the third transmission antenna, the transmission unit 200 sequentially maps the CSRS using the subcarrier indexes k calculated from the Equation (1) by the first calculation unit 110 to transmit the mapped CSRS, and punctures the subcarrier indexes k calculated from the Equation (2) by the second calculation unit 120 to thereby prevent all signals from being transmitted. At a time of the OFDM symbol #1 of the even slot transmitted through the fourth transmission antenna, the transmission unit 200 sequentially maps the CSRS using the subcarrier indexes k calculated from the Equation (2) by the second calculation unit 120 to transmit the mapped CSRS, and punctures the subcarrier indexes k calculated from the Equation (1) by the first calculation unit 110 to prevent all signals from being transmitted.

At a time of the OFDM symbol #1 of the odd slot transmitted through the third transmission antenna, the transmission unit 200 sequentially maps the CSRS using the subcarrier indexes k calculated from the Equation (2) by the second calculation unit 120 to transmit the mapped CSRS, and punctures the subcarrier indexes k calculated from the Equation (1) by the first calculation unit 110 to prevent all signals from being transmitted. At a time of the OFDM symbol #1 of the odd slot transmitted through the fourth transmission antenna, the transmission unit 200 sequentially maps the CSRS using the subcarrier indexes k calculated from the Equation (1) by the first calculation unit 110 to transmit the mapped CSRS, and punctures the subcarrier indexes k calculated from the Equation (2) by the second calculation unit 120 to prevent all signals from being transmitted.

Embodiments of the present invention very simply calculate the subcarrier indexes for transmitting CSRS, and puncture the subcarrier indexes which are not used in the resource allocation mapping and transmitting of the CSRS performed using the calculated subcarrier indexes, thereby enabling to very easily implement the base-station modulator. Accordingly, embodiments of the present invention enable to more quickly implement the base-station modulator applied to an LTE-Advanced system that is one of IMT-Advanced candidate technologies, and consequently can save the time and the cost.

In the implementation of hardware (H/W), embodiments of the present invention implement the N_{ID}^{cell} mod 6 and N_{ID}^{cell} mod 3 of the Equations in a software (S/W) region, and implement the method for the resource allocation of the CSRS and the puncturing of the subcarrier using the remaining portions of the Equations and the calculated subcarrier index in a hardware region, thereby decreasing the complexity of hardware. Accordingly, embodiments of the present invention can save the resource required upon implementation, and can save the time and the cost spent upon implementation.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims. For example, the present invention may be embodied in different forms such as record medium where a program for realizing a control method of the present invention is recorded.

What is claimed is:

1. A resource allocation mapping method for transmitting a Cell-Specific Reference Signal (CSRS), the resource allocation mapping method comprising:
calculating subcarrier indexes to allocate same subcarrier index to base stations that have same remainder when a base-station index, which classifies the base stations, is divided by a constant; and
mapping a resource allocation of the CSRS for the each base station using the calculated subcarrier indexes.

2. The resource allocation mapping method of claim 1, wherein the calculating of subcarrier indexes comprises calculating the subcarrier indexes using Equation below,
k=m×6+N_{ID}^{cell} mod 6, m=0,1, . . . , 2·N_{RB}^{DL}−1
where N_{ID}^{cell} is the base-station index, and N_{RB}^{DL} is the total number of resource blocks used in the down-link from the each base station.

3. The resource allocation mapping method of claim 1, wherein the calculating of the subcarrier indexes comprises calculating the subcarrier indexes using Equation below,
$$k = \{ \begin{matrix}m \times 6 + {N}_{ID}^{cell} mod 3 , m = 0 , 1 , … , 2 \cdot {N}_{RB}^{DL} - 1 & if {N}_{ID}^{cell} mod 6 > 2 \\ m \times 6 + {N}_{ID}^{cell} mod 3 + 3 , m = 0 , 1 , … , 2 \cdot {N}_{RB}^{DL} - 1 & if {N}_{ID}^{cell} mod 6 \leq 2\end{matrix}$$
where N_{ID}^{cell} is the base-station index, and N_{RB}^{DL} is the total number of resource blocks used in the down-link from the each base station.

4. The resource allocation mapping method of claim 1, wherein the mapping of the resource allocation comprises mapping the calculated subcarrier indexes with the CSRS in consideration of the number of transmission antennas, a transmission antenna index and a position of a transmitted Orthogonal Frequency Division Multiplexing (OFDM) symbol.

5. A resource allocation mapping method for transmitting a Cell-Specific Reference Signal (CSRS), the resource allocation mapping method comprising:
calculating subcarrier indexes using Equations (1) and (2) below; and
mapping a resource allocation of the CSRS using the calculated subcarrier indexes,
$$\begin{matrix} k = m \times 6 + {N}_{ID}^{cell} mod 6 , m = 0 , 1 , … , 2 \cdot {N}_{RB}^{DL} - 1 & ( 1 ) \\ k = \{ \begin{matrix}m \times 6 + {N}_{ID}^{cell} mod 3 , m = 0 , 1 , … , 2 \cdot {N}_{RB}^{DL} - 1 & if {N}_{ID}^{cell} mod 6 > 2 \\ m \times 6 + {N}_{ID}^{cell} mod 3 + 3 , m = 0 , 1 , … , 2 \cdot {N}_{RB}^{DL} - 1 & if {N}_{ID}^{cell} mod 6 \leq 2\end{matrix} & ( 2 )\end{matrix}$$
where N_{ID}^{cell} is an index given to each base station, and N_{RB}^{DL} is the total number of resource blocks used in the down-link from the each base station.

6. The resource allocation mapping method of claim 5, wherein the mapping of the resource allocation comprises:
sequentially mapping the subcarrier indexes calculated by the Equation (1) with the CSRS at a position of a first Orthogonal Frequency Division Multiplexing (OFDM) symbol transmitted through one transmission antenna; and
sequentially mapping the subcarrier indexes calculated by the Equation (2) with the CSRS at a position of a second OFDM symbol transmitted through the transmission antenna.

7. The resource allocation mapping method of claim 6, wherein the mapping of the resource allocation is identically applied to an even slot and an odd slot where the CSRS is transmitted.

8. The resource allocation mapping method of claim 5, wherein the mapping of the resource allocation comprises:
sequentially mapping the subcarrier indexes calculated by the Equation (1) with the CSRS, and puncturing the subcarrier indexes calculated by the Equation (2), at a position of a first Orthogonal Frequency Division Multiplexing (OFDM) symbol transmitted through a first transmission antenna;
sequentially mapping the subcarrier indexes calculated by the Equation (2) with the CSRS, and puncturing the subcarrier indexes calculated by the Equation (1), at a position of a second OFDM symbol transmitted through the first transmission antenna;
sequentially mapping the subcarrier indexes calculated by the Equation (2) with the CSRS, and puncturing the subcarrier indexes calculated by the Equation (1), at the position of the first OFDM symbol transmitted through a second transmission antenna; and
sequentially mapping the subcarrier indexes calculated by the Equation (1) with the CSRS, and puncturing the subcarrier indexes calculated by the Equation (2), at the position of the second OFDM symbol transmitted through the second transmission antenna.

9. The resource allocation mapping method of claim 8, wherein the mapping of the resource allocation is identically applied to an even slot and an odd slot where the CSRS is transmitted.

10. The resource allocation mapping method of claim 8, wherein the mapping of the resource allocation further comprises:
puncturing the subcarrier indexes calculated by the Equations (1) and (2) at a third OFDM symbol position of the first and second transmission antennas;
puncturing the subcarrier indexes calculated by the Equations (1) and (2) at the first and second OFDM symbol positions of third and fourth transmission antennas;
mapping the subcarrier indexes calculated by the Equation (1) with the CSRS, and puncturing the subcarrier indexes calculated by the Equation (2), at the third OFDM symbol position of an even slot transmitted through the third transmission antenna;
mapping the subcarrier indexes calculated by the Equation (2), and puncturing the subcarrier indexes calculated by the Equation (1), at the third OFDM symbol position of an even slot transmitted through the fourth transmission antenna;
mapping the subcarrier indexes calculated by the Equation (2), and puncturing the subcarrier indexes calculated by the Equation (1), at the third OFDM symbol position of an odd slot transmitted through the third transmission antenna; and
mapping the subcarrier indexes calculated by the Equation (1), and puncturing the subcarrier indexes calculated by the Equation (2), at the third OFDM symbol position of an odd slot transmitted through the fourth transmission antenna.

11. A Cell-Specific Reference Signal (CSRS) transmitting apparatus, comprising:
a calculation unit calculating subcarrier indexes to allocate the same subcarrier index to base stations that have same remainder when a base-station index, which classifies the base stations, is divided by a constant; and
a transmission unit mapping a resource allocation of the CSRS for the each base station using the calculated subcarrier indexes to transmit the mapped CSRS.

12. The CSRS transmitting apparatus of claim 11, wherein the calculation unit calculates the subcarrier indexes using Equation below,
k=m×6+N_{ID}^{cell} mod 6, m=0,1, . . . , 2·N_{RB}^{DL}−1
where N_{ID}^{cell} is the base-station index, and N_{RB}^{DL} is the total number of resource blocks used in the down-link from the each base station.

13. The CSRS transmitting apparatus of claim 11, wherein the calculation unit calculates the subcarrier indexes using Equation below,
$$k = \{ \begin{matrix}m \times 6 + {N}_{ID}^{cell} mod 3 , m = 0 , 1 , … , 2 \cdot {N}_{RB}^{DL} - 1 & if {N}_{ID}^{cell} mod 6 > 2 \\ m \times 6 + {N}_{ID}^{cell} mod 3 + 3 , m = 0 , 1 , … , 2 \cdot {N}_{RB}^{DL} - 1 & if {N}_{ID}^{cell} mod 6 \leq 2\end{matrix}$$
where N_{ID}^{cell} is the base-station index, and N_{RB}^{DL} is the total number of resource blocks used in the down-link from the each base station.

14. The CSRS transmitting apparatus of claim 11, wherein the transmission unit maps the calculated subcarrier indexes with the CSRS in consideration of the number of transmission antennas, a transmission antenna index and a position of a transmitted Orthogonal Frequency Division Multiplexing (OFDM) symbol.

15. A Cell-Specific Reference Signal (CSRS) transmitting apparatus, comprising:
first and second calculation units calculating subcarrier indexes using Equations (1) and (2) below; and
a transmission unit mapping a resource allocation of the CSRS using the calculated subcarrier indexes to transmit the mapped CSRS,
$$\begin{matrix} k = m \times 6 + {N}_{ID}^{cell} mod 6 , m = 0 , 1 , … , 2 \cdot {N}_{RB}^{DL} - 1 & ( 1 ) \\ k = \{ \begin{matrix}m \times 6 + {N}_{ID}^{cell} mod 3 , m = 0 , 1 , … , 2 \cdot {N}_{RB}^{DL} - 1 & if {N}_{ID}^{cell} mod 6 > 2 \\ m \times 6 + {N}_{ID}^{cell} mod 3 + 3 , m = 0 , 1 , … , 2 \cdot {N}_{RB}^{DL} - 1 & if {N}_{ID}^{cell} mod 6 \leq 2\end{matrix} & ( 2 )\end{matrix}$$
where N_{ID}^{cell} is an index given to the each base station, and N_{RB}^{DL} is the total number of resource blocks used in the down-link from the each base station.

16. The CSRS transmitting apparatus of claim 15, wherein the transmission unit comprises one transmission antenna,
wherein the transmission unit sequentially maps the subcarrier indexes calculated by the Equation (1) with the CSRS at a position of a first Orthogonal Frequency Division Multiplexing (OFDM) symbol of an even slot and an odd slot transmitted through the transmission antenna, and sequentially maps the subcarrier indexes calculated by the Equation (2) with the CSRS at a position of a second OFDM symbol of the even and odd slots transmitted through the transmission antenna.

17. The CSRS transmitting apparatus of claim 15, wherein the transmission unit comprises first and second transmission antennas,
wherein:
the transmission unit sequentially maps the subcarrier indexes calculated by the Equation (1) with the CSRS, and puncturing the subcarrier indexes calculated by the Equation (2), at a position of a first Orthogonal Frequency Division Multiplexing (OFDM) symbol of an even slot and an odd slot transmitted through the first transmission antenna,
the transmission unit sequentially maps the subcarrier indexes calculated by the Equation (2) with the CSRS, and puncturing the subcarrier indexes calculated by the Equation (1), at a position of a second OFDM symbol of the even and odd slots transmitted through the first transmission antenna,
the transmission unit sequentially maps the subcarrier indexes calculated by the Equation (2) with the CSRS, and puncturing the subcarrier indexes calculated by the Equation (1), at the position of the first OFDM symbol of an even slot and an odd slot transmitted through the second transmission antenna, and
the transmission unit sequentially maps the subcarrier indexes calculated by the Equation (1) with the CSRS, and puncturing the subcarrier indexes calculated by the Equation (2), at the position of the second OFDM symbol of the even and odd slots transmitted through the second transmission antenna.

18. The CSRS transmitting apparatus of claim 17, wherein the transmission unit further comprises third and fourth transmission antennas:
wherein:
the transmission unit punctures the subcarrier indexes calculated by the Equations (1) and (2) at a third OFDM symbol position of an even slot and an odd slot transmitted through the first and second transmission antennas,
the transmission unit punctures the subcarrier indexes calculated by the Equations (1) and (2) at the first and second OFDM symbol positions of the even and odd slots transmitted through the third and fourth transmission antennas,
the transmission unit maps the subcarrier indexes calculated by the Equation (1), and puncturing the subcarrier indexes calculated by the Equation (2), at the third OFDM symbol position of the even slot transmitted through the third transmission antenna,
the transmission unit punctures maps the subcarrier indexes calculated by the Equation (2), and puncturing the subcarrier indexes calculated by the Equation (1), at the third OFDM symbol position of the even slot transmitted through the fourth transmission antenna,
the transmission unit maps the subcarrier indexes calculated by the Equation (2), and puncturing the subcarrier indexes calculated by the Equation (1), at the third OFDM symbol position of the odd slot transmitted through the third transmission antenna, and
the transmission unit maps the subcarrier indexes calculated by the Equation (1), and puncturing the subcarrier indexes calculated by the Equation (2), at the third OFDM symbol position of the odd slot transmitted through the fourth transmission antenna.
